(19) United States
(12) Patent Application Publication
(10) Pub. No.: US 2015/0006652 A1
(43) Pub. Date: Jan. 1, 2015

(54) METHODS AND SYSTEMS FOR ANONYMOUS COMMUNICATION TO SURVEY RESPONDENTS

(71) Applicant: Thymometrics Limited, Cambridge (GB)

(72) Inventors: Hugh Tonks, Longstanton (GB); Jeremy Michael Pett, Fenstanton (GB)

(21) Appl. No.: 14/309,913

(22) Filed: Jun. 20, 2014

Related U.S. Application Data
(60) Provisional application No. 61/840,410, filed on Jun. 27, 2013.

(51) Int. Cl. H04L 29/06

(52) U.S. Cl. CPC H04L 63/0421
USPC 709/206

(57) ABSTRACT

A method for anonymous communication to survey respondents includes providing, by a first computing device, to a second computing device, access to a visualization representing data in a plurality of survey responses. The method includes receiving, by the first computing device, from the second computing device, an identification of a type of at least one data point represented in the visualization. The method includes identifying, by the first computing device, a plurality of survey respondents, each of the plurality having generated at least one data point of the identified type in the plurality of survey responses. The method includes generating, by the first computing device, a messaging group including the identified plurality of survey respondents. The method includes forwarding, by the first computing device, to the messaging group, a message from the second computing device.

### CROSS-REFERENCE TO RELATED APPLICATIONS

This application claims priority from U.S. Provisional Patent Application No. 61/840,410, filed on Jun. 27, 2013, entitled “Methods and Systems for Anonymous Communication to Survey Respondents,” which is hereby incorporated by reference.

### BACKGROUND

The disclosure relates to anonymous communication. More particularly, the methods and systems described herein relate to anonymous communication between survey respondents and individuals receiving survey results.

Conventional methods for surveying individuals typically ensure the anonymity of the individual responding to the survey. However, while such methods provide anonymity when receiving data from the individuals, these methods do not typically provide functionality with which an individual receiving a survey result can send a message to an individual responding to the survey.

### BRIEF SUMMARY

In one aspect, a method for anonymous communication to survey respondents includes providing, by a first computing device, to a second computing device, access to a visualization representing data in a plurality of survey responses. The method includes receiving, by the first computing device, from the second computing device, an identification of a type of at least one data point represented in the visualization. The method includes identifying, by the first computing device, a plurality of survey respondents, each of the plurality having generated at least one data point of the identified type in the plurality of survey responses. The method includes generating, by the first computing device, a messaging group including the identified plurality of survey respondents. The method includes forwarding, by the first computing device, to the messaging group, a message from the second computing device.

In another aspect, a method for analysis of groups of survey respondents includes providing, by a first computing device, to a second computing device, access to a visualization representing data in a plurality of survey responses. The method includes receiving, by the first computing device, from the second computing device, an identification of a type of at least one data point represented in the visualization. The method includes identifying, by the first computing device, a plurality of survey respondents, each of the plurality having generated at least one data point of the identified type in the plurality of survey responses. The method includes generating, by the first computing device, a group including the identified plurality of survey respondents. The method includes providing, by the first computing device, to the second computing device, access to a result of a statistical analysis of the plurality of survey responses provided by the plurality of survey respondents in the group.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2A is a block diagram depicting an embodiment of a system for anonymous communication to a survey respondent;

FIG. 2B is a block diagram depicting one embodiment of a user interface for rating factors;

FIG. 2C is a block diagram depicting one embodiment of a visualization of captured ratings;

FIG. 2D is a block diagram depicting one embodiment of a user interface for creating a group;

FIG. 2E is a block diagram depicting one embodiment of a user interface for sending an anonymous message to a group;

FIG. 2F is a block diagram depicting one embodiment of a user interface with which survey response recipients may view and anonymously respond to survey respondent messages;

FIG. 2G is a block diagram depicting one embodiment of a user interface with which users may view analyses of captured ratings;

FIG. 2H is a block diagram depicting one embodiment of a user interface with which a user may specify parameters of a ratings analysis;

FIG. 3A is a flow diagram depicting an embodiment of a method for anonymous grouping of at least one survey respondent;

FIG. 3B is a flow diagram depicting an embodiment of a method for anonymous communication to at least one survey respondent; and

FIG. 3C is a flow diagram depicting an embodiment of a method for providing access to results of statistical analyses based on a plurality of survey responses.

### DETAILED DESCRIPTION

In some embodiments, the methods and systems described herein provide functionality for anonymous communication to a survey respondent. Before describing these methods and systems in detail, however, a description is provided of a network in which such methods and systems may be implemented.

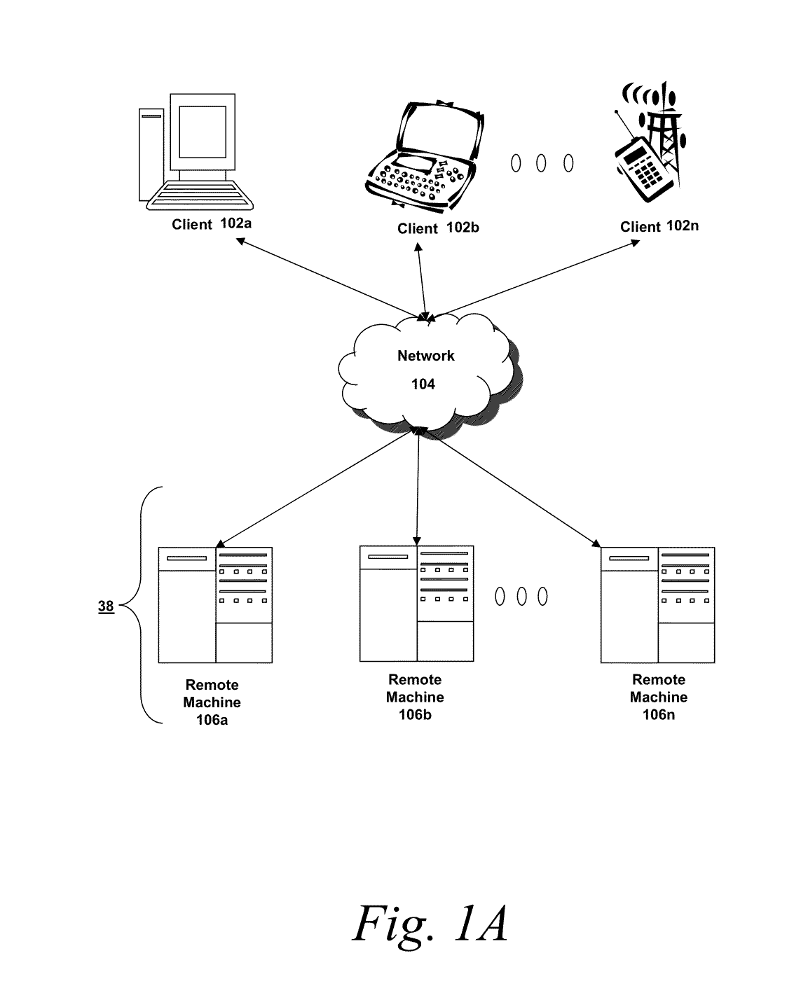

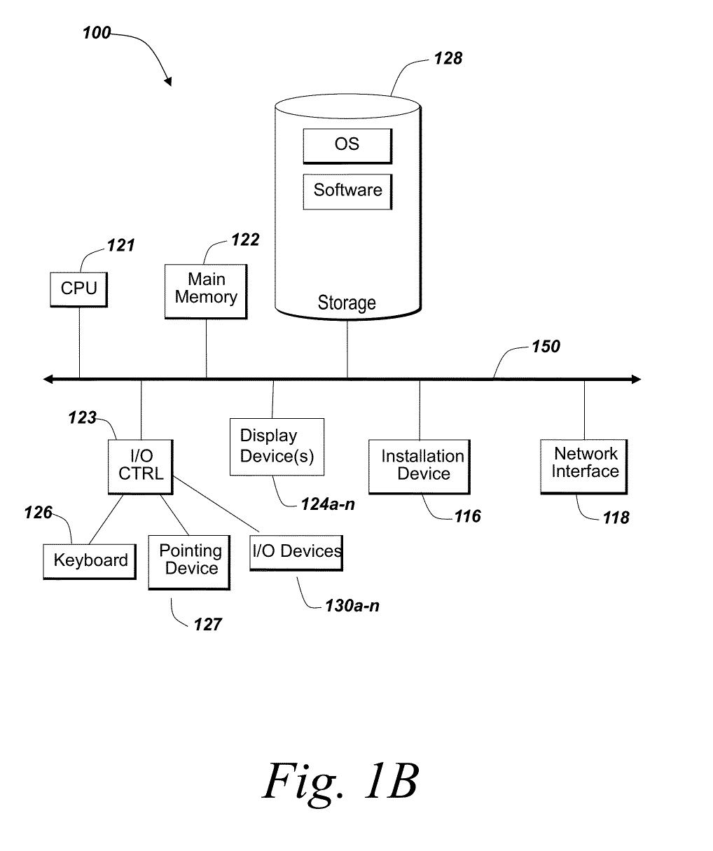

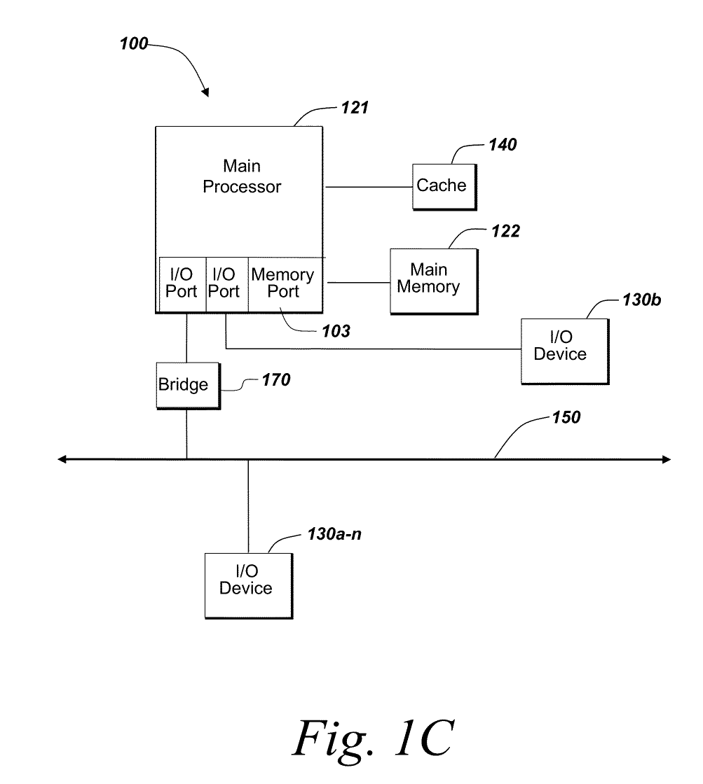

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation; desktop computer; laptop or notebook computer; server; portable computer; mobile telephone or other portable telecommunication device; media playing device; a gaming system; a mobile computing device; or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server such as the APACHE servers maintained by the Apache Software Foundation of Delaware. In other embodiments, the web server executes proprietary software such as the Internet Information Services products provided by Microsoft Corporation of Redmond, Wash.; the Oracle iPlanet web server products provided by Oracle Corporation of Redwood Shores, Calif.; or the BEA WEBLOGIC products provided by BEA Systems of Santa Clara, Calif. In further embodiments, a computing device 106 executes self-replication software. In one of these embodiments, execution of the self-replication software allows a computing device 106a to direct a second computing device 106b to provide a copy of data stored by the computing device 106. For example, the computing device 106a may provide access to a web site and, upon execution of the self-replication software, direct the second computing device 106b to provide access to a copy of the web site.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

The main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. An I/O controller 123 as shown in FIG. 1B may control the I/O devices. Furthermore, an I/O device may also provide storage and/or an installation device 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, each of which may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada (doing business as “Blackberry”). In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc. of Cupertino, Calif. In another of these embodiments, the digital audio player may function as both a portable media player and as a mass storage device. In other embodiments, the computing device 100 is a digital audio player such as those manufactured by, for example and without limitation, Samsung Electronics America of Ridgefield Park, N.J., Motorola Inc. of Schaumburg, Ill., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea or HTC Headquarters of Taiwan, R.O.C. In other embodiments, the computing device 100 is a tablet device such as, for example and without limitation, the iPad line of devices manufactured by Apple Inc.; the PlayBook manufactured by Research In Motion; the Cruz line of devices manufactured by Velocity Micro, Inc. of Richmond, Va.; the Folio and Thrive line of devices manufactured by Toshiba America Information Systems, Inc. of Irvine, Calif.; the Galaxy line of devices manufactured by Samsung; the HP Slate line of devices manufactured by Hewlett-Packard; and the Streak line of devices manufactured by Dell, Inc. of Round Rock, Tex.

In some embodiments, the methods and systems described herein provide functionality for anonymous communication to a survey respondent. In contrast to conventional surveying systems and methods that do not typically provide a way for a survey responder and a survey results recipient to communicate anonymously after completion of a survey, the methods and systems described herein provide functionality allowing the survey results recipient to both select survey responders and transmit data to the selected survey responders without having access to the identity of the survey responders. In some embodiments, implementation of the methods and systems described herein provide functionality allowing survey results recipients to track survey responder sentiment over time, communicate with the survey responders, and determine a level of impact of actions taken in response to received survey results.

In some embodiments, the methods and systems described herein facilitate the exchange of views between a set of people and an organizational entity by collecting views from said people and facilitating communication between said people and said entity. Typically, the said entity may be a person, a company, or other organization, and the said sets of people may be drawn from a population that has some common relationship with said entity, the membership of said sets being possibly but not necessarily mutually exclusive. Particular instances of this relationship include, without limitation:
The entity comprising an employer, and the population comprising the entity's employees;
The entity comprising an employer, and the population comprising the entity's employees and agents;
The entity comprising an educational establishment, and the population comprising its student body;
The entity comprising an educational establishment, and the population comprising its student body and a set of independent counselors;
The entity comprising an educational establishment, and the population comprising the legal guardians of its student body;
The entity comprising a service provider, and the population comprising the users of said service;
The entity comprising a product manufacturer, and the population comprising the users of said product;
The entity comprising a wholesaler or retailer, and the population comprising its customers;
The entity comprising a charity or not-for-profit organization, and the population comprising benefactors to or beneficiaries of said entity;
The entity comprising a well-known person, and the population comprising people with an interest in said entity;
The entity comprising an organization managing a public or private attraction or event, and the population comprising potential or actual visitors to that attraction or event;
The entity comprising a housing management organization, and the population comprising its tenants;
The entity comprising a governmental organization, and the population comprising the inhabitants or frequenters of the territory governed; and
The entity comprising an organization that carries out a poll or survey, and the population comprising those people to be polled or surveyed.

Hereinafter, the entity shall be referred to as the “client” and members of a related population shall be referred to as “users.” Usage of any part of the system by a client may be carried out by a subset of users nominated by the client and by any third parties acting on behalf of the client; said users and third parties may be referred to as “authorized users.” The client may determine from time to time which parts of the system may be accessed by each of the authorized users and which users are authorized users. The term “client” shall be understood to include all “authorized users” that are given access by the client to whatever aspect of the system.

In one embodiment, a client may permit and deny usage of the system or parts thereof to users, and to amend said permissions from time to time. Typically, a user may be denied further access to the system if the person who is that user ceases to be an eligible member of the population of users (becomes an “ex-user”), for example when a person ceases to be an employee of a company.

In some embodiments, an entity may participate in multiple relationships simultaneously, for example a school may be an employer to its employees, and an educational establishment to its students and to its students' legal guardians. In some instantiations, an individual may be a member of a plurality of populations each simultaneously having a separate relationship with an entity. In some instantiations, there may be a plurality of said different kinds of plural relationships extant.

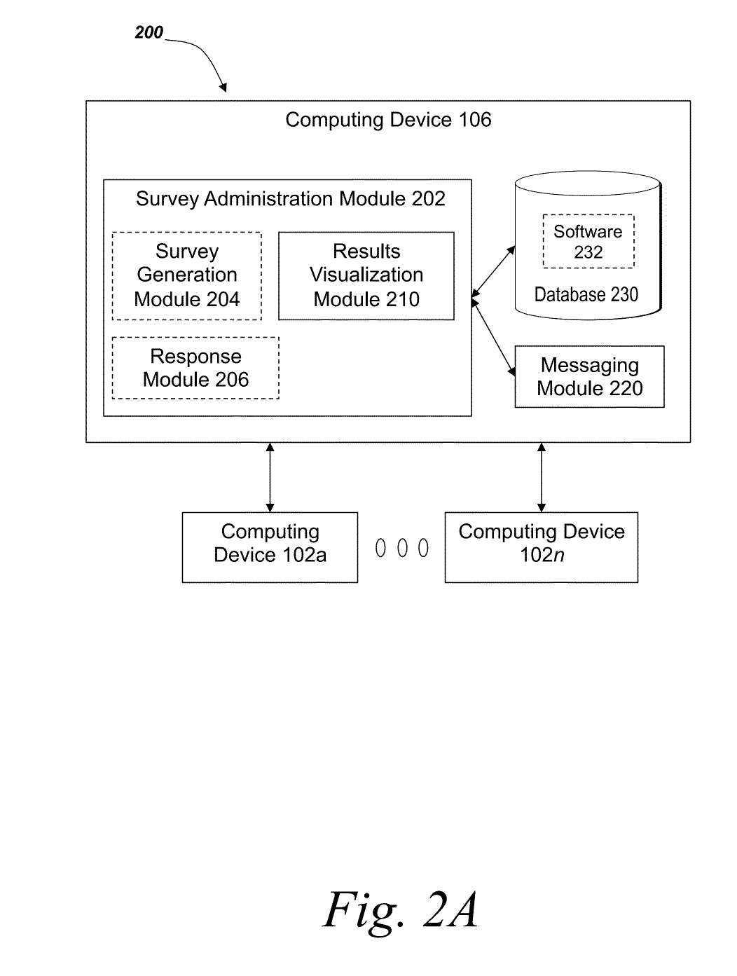

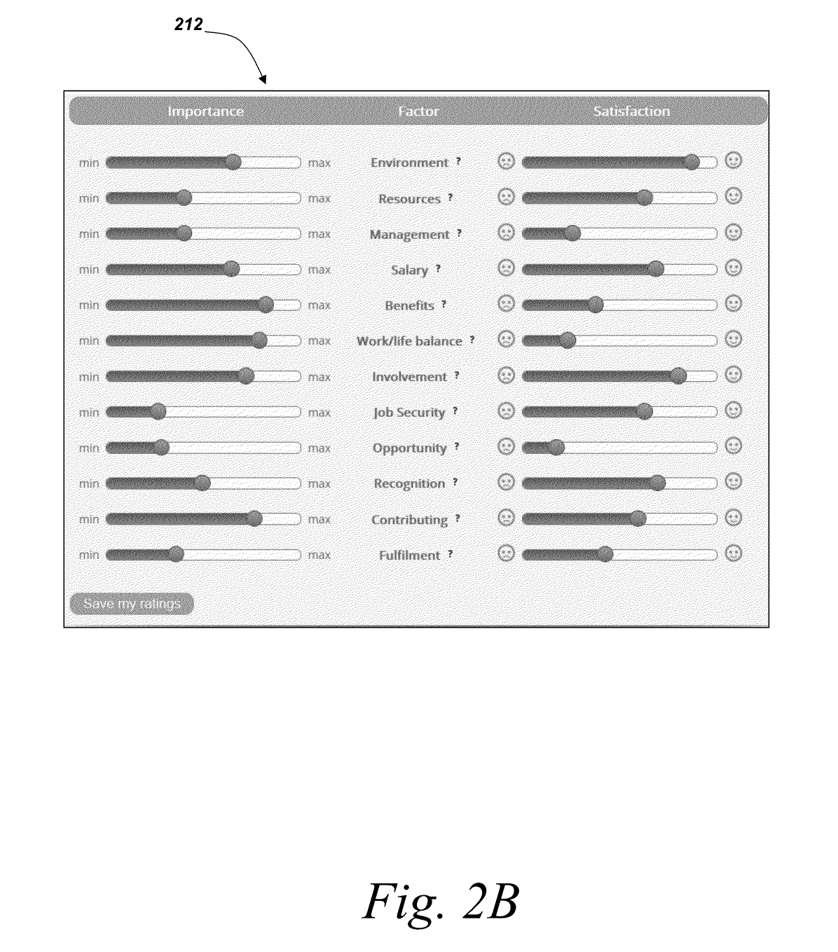

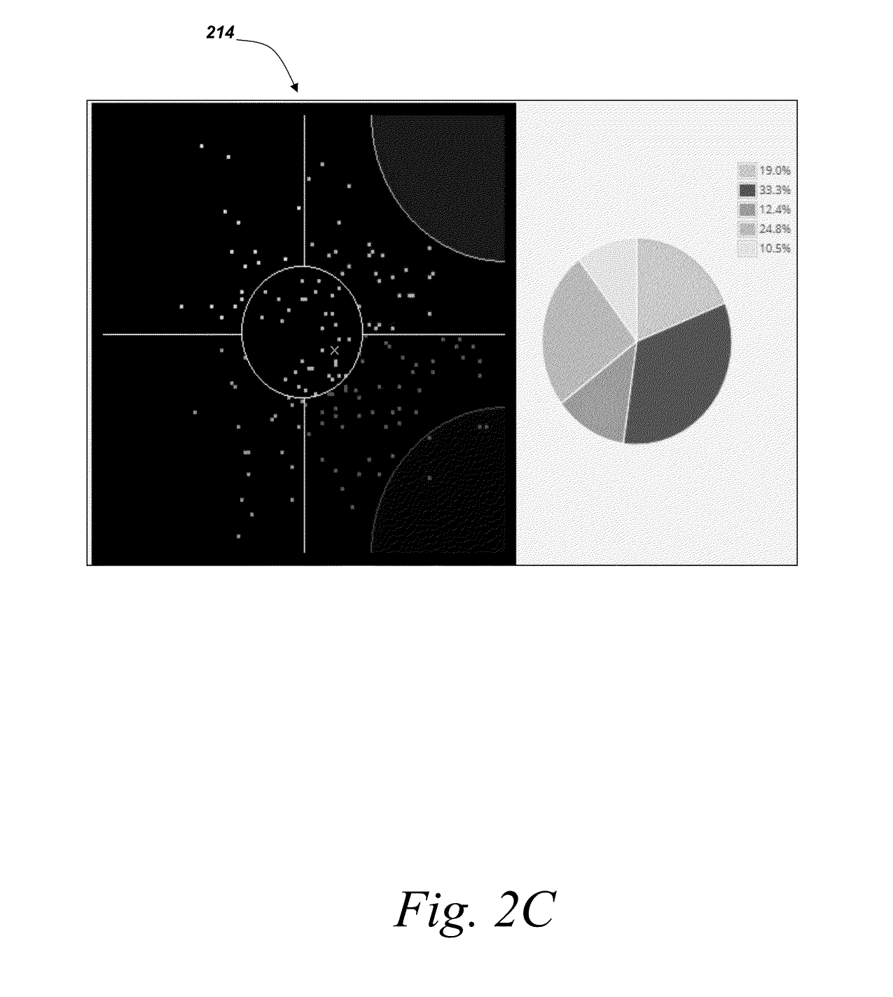

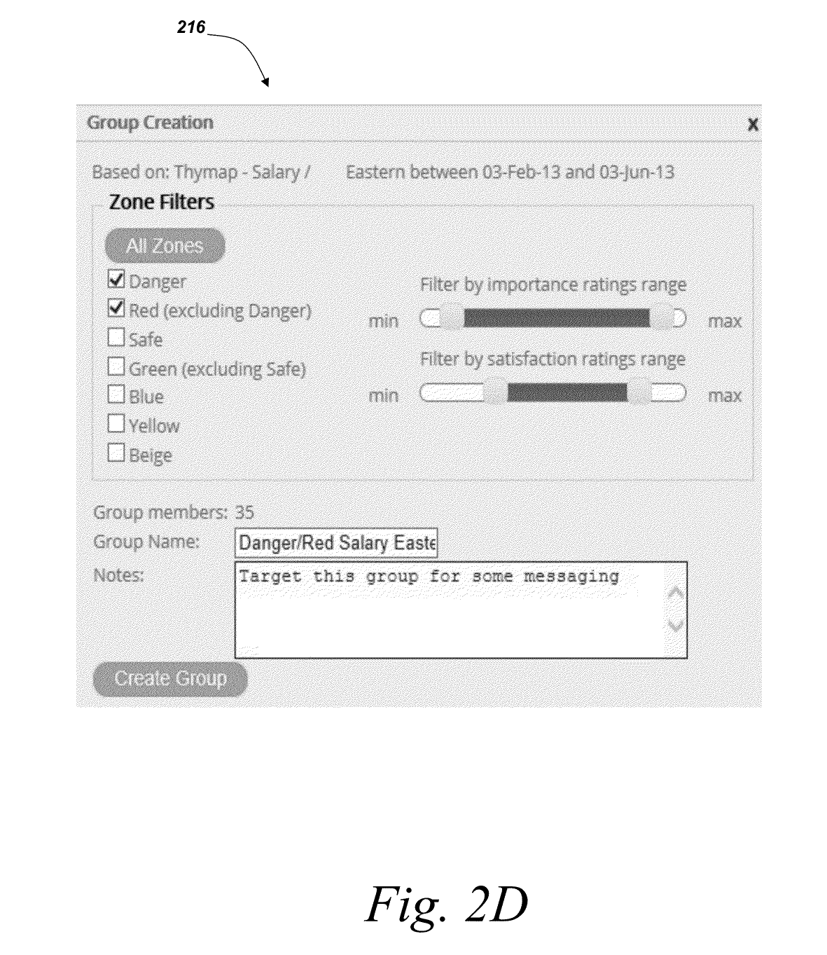

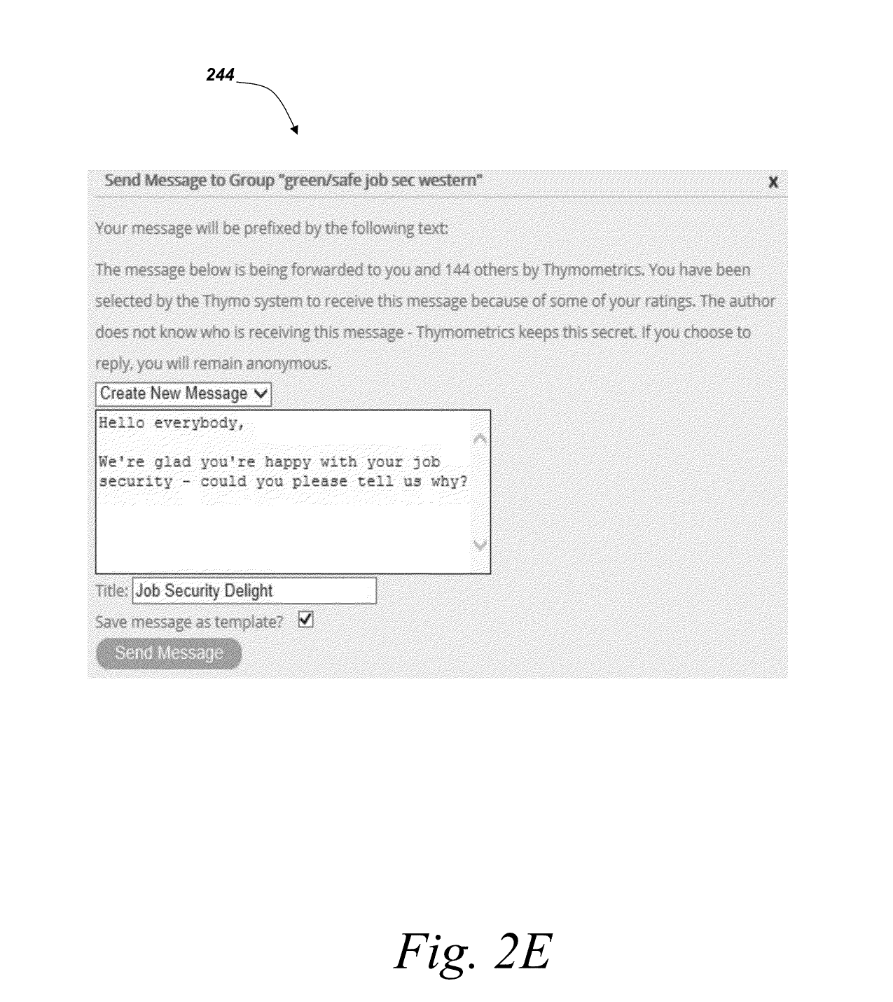

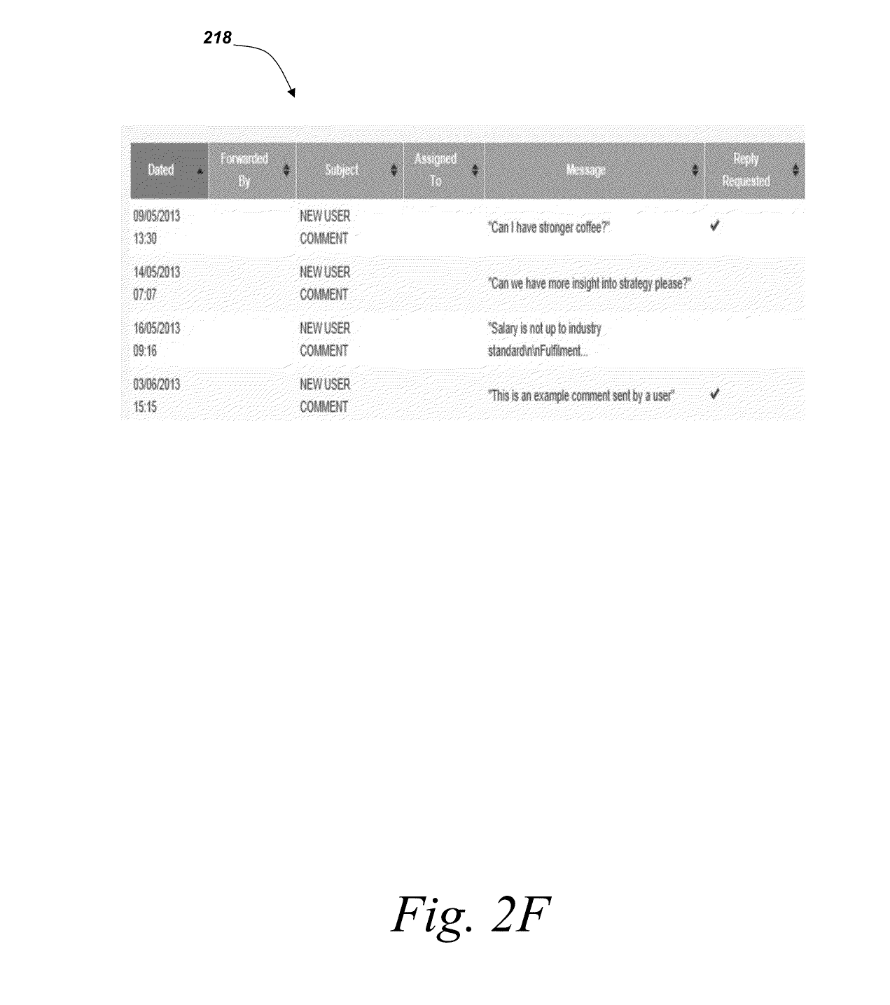

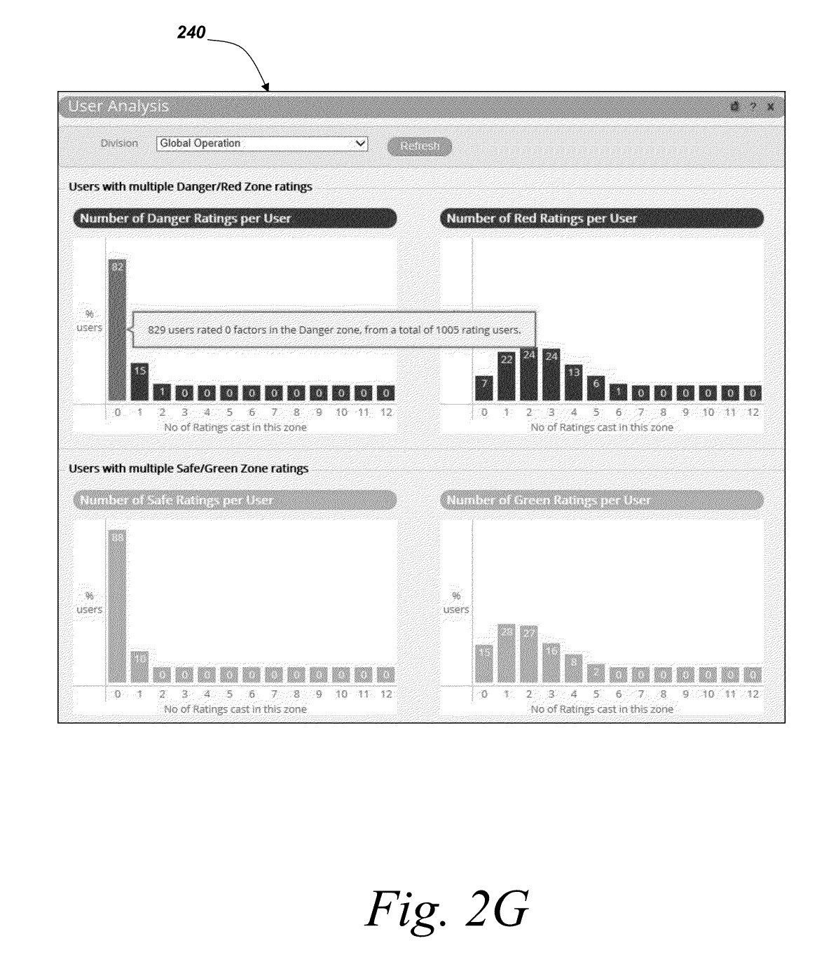

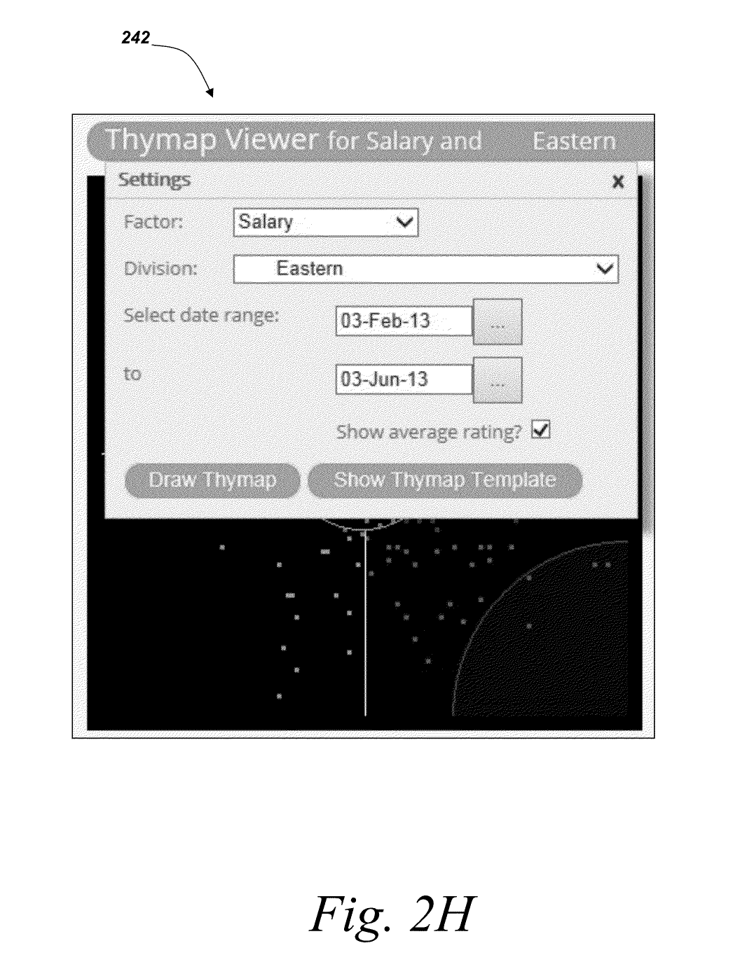

Referring now to FIG. 2A, a block diagram depicts one embodiment of a system 200 for anonymous communication to a survey respondent. In brief overview, the system 200 includes computing devices 102a-n (referred to generally as a computing device 102) and a computing device 106. The computing devices 102 and the computing device 106 may be provided as machines 100, as described in connection with FIGS. 1A-1C above. The computing device 106 includes a survey administration module 202, a results visualization module 210, a messaging module 220, and a database 230. The survey administration module 202 may include a survey generation module 204. The survey administration module 202 may include a response module 206. The database 230 may execute software 232.

In one embodiment, the survey administration module 202 executes on the computing device 106. In another embodiment, the survey administration module 202 is provided as a software application. In another embodiment, the survey administration module 202 is provided as a hardware application.

In some embodiments, the survey administration module 202 includes a survey generation module 204. In one of these embodiments, the survey generation module 204 provides functionality for capturing user responses to surveys, which may also be referred to as survey response data received from a plurality of survey respondents. For example, the survey generation module 204 may receive instructions from a client regarding what questions to present to the users and then generate a user interface displaying the questions to the users and receiving their responses. Since survey questions typically ask users to rate a quality of a factor (e.g., rate a level of satisfaction with a salary), survey responses may also be referred to as ratings. In one embodiment, an internal scale is used to record the numerical values of ratings received in survey responses, although such an embodiment may record the numerical values without revealing this internal scale to the client or to the users, permitting number-free controls to be displayed to the user for the purpose of capturing ratings.

In some embodiments, the survey generation module 204 provides a user interface with which the client can identify factors for which the system 200 should capture ratings. In other embodiments, the survey administration module 202 executes a response module 206 with which users can provide ratings data. In some embodiments, a user computing device 102a transmits a user's rating to the response module 206. In one of these embodiments, the response module 206 stores the user rating in a database 230.

Referring now to FIG. 2B, a block diagram depicts one embodiment of a user interface 212 for rating factors. As shown in the embodiment depicted by FIG. 2B, the user interface 212 enumerates a plurality of factors (e.g., without limitation, environment, resources, management, salary, benefits, and job security) and two qualities for each factor (e.g., a level of importance and a level of satisfaction). The user interface 212 may provide a user interface element with which users may rate qualities. As shown in FIG. 2B, the user interface element is a slider with which the user may indicate her rating for a level of satisfaction (or other qualities) of a particular factor. In other embodiments, the user interface element may be a radio button with which users select a rating (e.g., high/medium/low, excellent/fair/poor) or a text box into which users may enter text characterizing their ratings. In one embodiment, the system 200 provides the user interface 212 for capturing a numerical representation (which may also be referred to as a rating) of at least one user's views of at least one quality of at least one factor; typically said factors may be aspects of a relationship between a client and users chosen because said aspects are considered by the client to be bellwethers of the relationship, although a factor could also be anything for which it would be meaningful to capture a rating on a quality of said factor. In one embodiment, the system 200 captures ratings on two qualities for each of at least one factor (said qualities including, for example, the importance to said user of said factor and said user's satisfaction with said factor). The process of capturing ratings may be referred to as surveying one or more users and users may therefore also be referred to as survey respondents.

Referring back FIG. 2A, the system 200 may provide functionality for capturing textual input (e.g., a note or comment providing feedback on a factor, a message between users and clients, or other textual input) from users and a client. In some embodiments, the system 200 is available to the client and the users for a fixed or variable period of time (e.g., for a year, or until notice to the contrary is given), during which time each user has the ability to submit for capture as many ratings and notes as desired by and at times chosen by said user.

Referring still to FIG. 2A, in one embodiment, the system 200 provides functionality for making an association between each of a plurality of the ratings of a user on a quality of a factor, said plurality of ratings having been captured over a period of time. These associations may be used in identifying pluralities of users during formation of groups or in analysis of ratings in user responses, as discussed below. In another embodiment, the system 200 also provides functionality for making an association between the ratings of a user on each of a plurality of qualities of the same factor; in one such embodiment, the system allows the simultaneous capture of the views of a user on both the importance of a factor to said user, and said user's satisfaction with the factor. In still another embodiment, the system allows an association to be made between the ratings captured from a user on a single quality of a plurality of factors. Yet another embodiment allows an association to be made between each of a plurality of ratings captured at substantially the same time from the same user.

In one embodiment, the system 200 allows an association to be made between the most recently captured ratings from a user for each quality of each factor. A further embodiment allows the linkage of a plurality of associations, whether such linkages are between associations involving a single user or a plurality of users.

In one embodiment, the system 200 allows an association to be made between each of a plurality of the notes captured from a user, said plurality of notes having been captured sequentially over a period of time. Another embodiment allows the association of a rating and a note when captured from the same user on the same occasion. A further embodiment allows a user to request that the client reply to a note captured from said user.

The system 200 includes a database 230 and its associated software 232, which creates time-stamped records of ratings and notes and associates them with the users (including authorized users) from whom they were captured, and (for ratings) with the related qualities and the factors. Instantiations of the database 230 may be designed to run for an extended period of time, capturing ratings and notes whenever users choose to submit them. In one embodiment, the database 230 is indexed to facilitate the particular analyses implemented by the system 200.

In one embodiment, the database 230 maintains links between records to allow the association of a plurality of ratings and notes with each other. In still another embodiment, the database 230 maintains records of the association of users to divisions and hence to division trees. In another embodiment, the database 230 maintains records of the association of authorized users to permissions defined by a client for accessing specific parts of the invention. Sundry other associations may be maintained in order to record associations between clients and users as defined by the possible relationships described herein. In one embodiment, these associations are maintained within a structured query language (SQL) database 230, the data being collected, processed, and retrieved by SQL Stored Procedures.

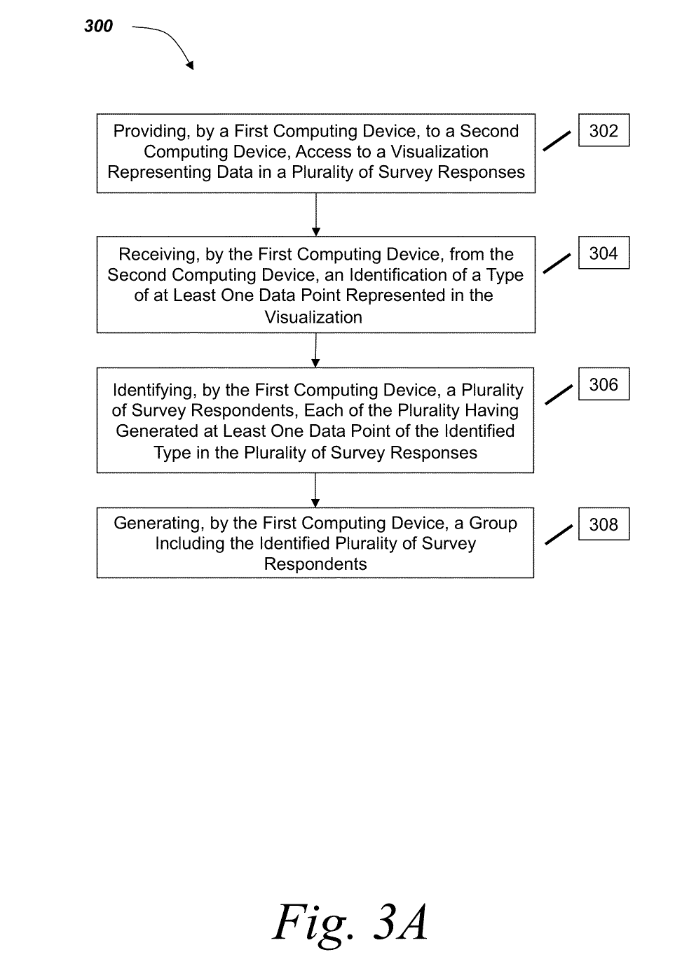

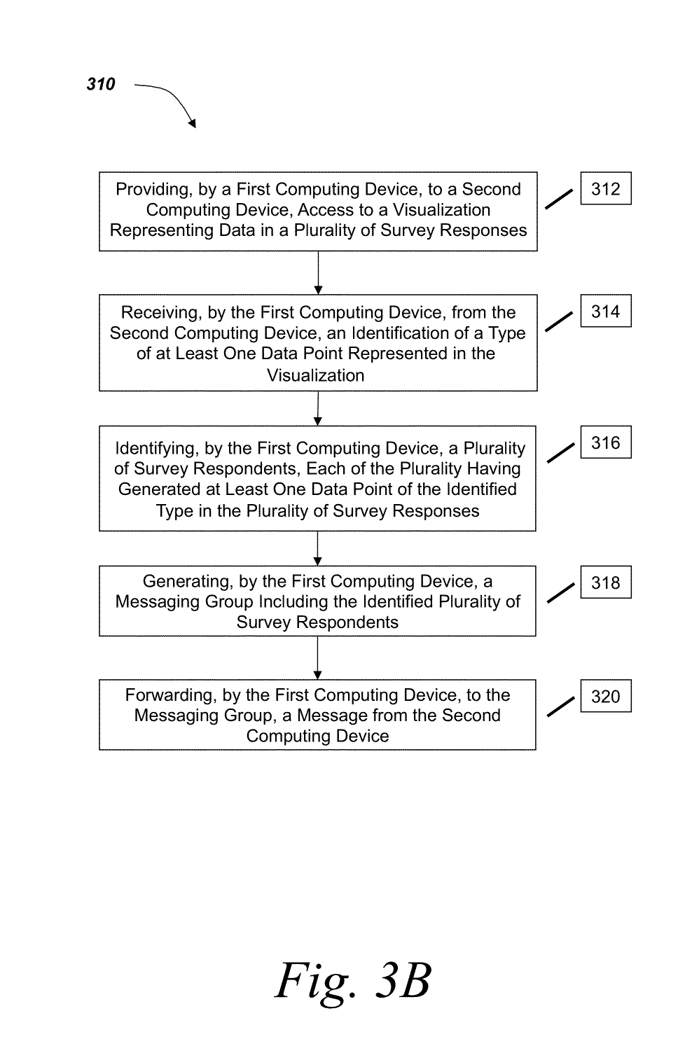

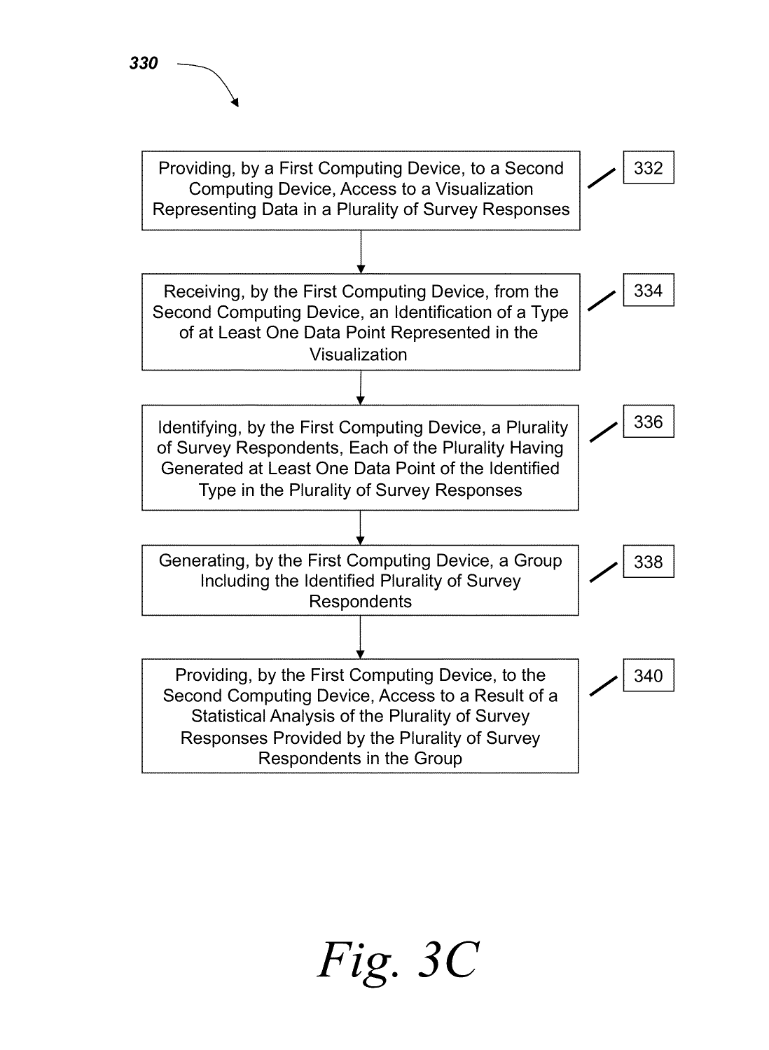

Referring now to FIG. 3A, a flow diagram depicts one embodiment of a method 300 for anonymous grouping of at least one survey respondent. In brief overview, the method 300 includes providing, by a first computing device, to a second computing device, access to a visualization representing data from a plurality of survey responses (302). The method 300 includes receiving, by the first computing device, from the second computing device, an identification of a type of at least one data point represented in the visualization (304). The method 300 includes identifying, by the first computing device, a plurality of survey respondents, each of the plurality having generated at least one data point of the identified type in the plurality of survey responses (306). The method 300 includes generating, by the first computing device, a group including the identified plurality of survey respondents (308).

Referring now to FIG. 3A in greater detail, and in connection with FIGS. 2A-2G, the first computing device 106 provides, to a second computing device 102, access to a visualization representing data from a plurality of survey responses (302). In some embodiments, the first computing device 106 provides access to the visualization after the survey administration module 202 captures survey response data.

In some embodiments, the survey administration module 202 includes functionality for generating a visualization of data from a plurality of survey responses. In one of these embodiments, the survey administration module 202 executes the results visualization module 210. In one embodiment, the results visualization module 210 executes on the computing device 106. In another embodiment, the results visualization module 210 is provided as a software application. In another embodiment, the results visualization module 210 is provided as a hardware application.

In some embodiments, the results visualization module 210 receives a data set. In other embodiments, the results visualization module 210 generates a data set. In one of these embodiments, the results visualization module 210 receives a plurality of survey responses and extracts data from each of the plurality of survey responses to generate the data set.

Referring now to FIG. 2C, a block diagram depicts one embodiment of a data visualization 214 of captured ratings. In some embodiments, the results visualization module 210 generates the visualization 214 based on a received or generated data set. For example, the results visualization module 210 may plot data points on a graph using the data set. The results visualization module 210 may execute customized software to generate the data visualization 214. Alternatively, the results visualization module 210 may execute commercially available software to generate the data visualization 214. In some embodiments, the visualization 214 provides a graphical representation of different aspects of the data set. For example, the visualization 214 may provide a graphical representation of one or more ratings captured from user responses to surveys.

In one embodiment, the results visualization module 210 presents a data visualization to the client in a manner that hides the identity of any user whose ratings are illustrated in the visualization. In another embodiment, an analysis is also presented to the client in a manner that hides the identity of any user whose ratings are used to generate said analysis. A further embodiment allows the obfuscation of the visualized information such that the overall impression gained by the client is substantially the same as the impression that would have been gained by the client from the original non-obfuscated visualization. For example, the system may obfuscate the visualized information by not displaying a proportion of data points or by blurring a set of data points. As another example, the system may obfuscate the visualized information by modifying a position of a data point.

Referring again to FIG. 3A, the first computing device 106 receives, from the second computing device, an identification of a type of at least one data point represented in the visualization (304). In receiving identifications of types of data points, the system 200 allows a client to define and name a subset of users, which may be referred to as a group of users, without the client knowing the identity of the users (e.g., the users generating the type of data point). In one embodiment, the client defines the group according to at least one criterion for inclusion, the criteria applied either individually or in combination. For example, the criteria may be a type of rating provided by a user for a particular factor between certain dates. The client may specify the type of the at least one data point by specifying the criteria. The criteria may include, without limitation:
Users from whom at least one rating or note was captured before a date specified by the client;
Users from whom at least one rating or note was captured on a date specified by the client;
Users from whom at least one rating or note was captured after a date specified by the client;
Users from whom at least one rating or note was captured during a date range specified by the client;
Users from whom at least one rating or note was captured before the end date of a date range specified by the client from those users who had at least one rating captured during said date range;
Users from whom at least one rating or note was captured before the end date of a date range specified by the client from those users who had at least one note captured during said date range;
Users from whom at least one rating was captured on at least one factor specified by the client;
Users from whom at least one rating was captured, said rating's numerical value being either more than, less than, or equal to a value specified by the client;
Users from whom at least one rating was captured, said rating's numerical value having changed by a specific amount specified by the client during a period of time specified by the client;
Users from whom at least one rating was captured, said rating's numerical value being between two values specified by the client;
Users from whom a plurality of ratings were captured, said ratings' numerical values being expressed as an n-dimensional tuple or equivalent form, said tuple falling within an n-dimensional region of the m-dimensional space defined by all possible values of said tuple of a shape specified by the client, where m is the number of different qualities for which a rating may be captured and n is the number of different qualities pertaining to said ratings and n is less than or equal to m;
Users for whom the numerical value of their ratings of a quality of a factor have changed by more or less than an amount specified by client during a period of time specified by the client;
Users having had captured the same quantity of ratings as, or more or fewer ratings than, a quantity specified by the client during a period of time specified by the client;
Users having had captured the same quantity of notes as, or more or fewer notes than, a quantity specified by the client during a period of time specified by the client;
Users having had captured a note with an appertaining classification specified by the client;
Users for whom the number of the most recent ratings provided on all factors having properties and values matching those specified by the client fall between upper and lower bounds also defined by the client (e.g., a client may specify that the system 200 should create a group including any users who recently rated at least six different factors as both important and unsatisfactory);
Users for whom a rating is substantially the same as a rating provided by other respondents in the group of survey respondents;
Users for whom a text-based response provided by the users included a client-specified keyword;
Users having had captured a note containing text specified by the client;
Users belonging to another group specified by the client;
Users not belonging to another group specified by the client;
Users belonging to all of a plurality of groups specified by the client;
Users belonging to at least one of a plurality of groups specified by the client; and
Users belonging to a group specified by the client, but not belonging to another group specified by the client.
   In some embodiments, the client is unaware of the identity of the users belonging to a group.

In one embodiment, the system 200 allows the client to create and modify at least one hierarchical classification system (which may be referred to herein as a “division tree”), each division tree comprising a hierarchy of nodes (which may be referred to herein as “divisions”) defined and named by the client; the client may assign and from time to time re-assign any of the users to a division within a division tree. In some embodiments, clients may assign users to divisions having no sub-hierarchy within the division tree hierarchy; such divisions may be referred to as “leaf divisions.” In these embodiments, criteria with which to create groups may include, without limitation, determining that users were previously assigned to a particular division, sub-division, or leaf division.

Referring now to FIG. 2D, a block diagram depicts one embodiment of a user interface 216 for creating a group. As shown in FIG. 2D, the user interface 216 may include user interface elements (such as sliders and checkmark boxes) with which a first user (such as an authorized user representing a client) specifies criteria for inclusion of a second user in a group. For example, the first user may indicate that the system 200 should create a group of users in which each user provided at least one rating that was shown in the data visualization in different colors or shadings for qualities having a particular level of importance and satisfaction as specified by the first user. In this example, the first user identifies attributes of a data point (depicted in a particular color and having particular levels of importance and satisfaction) and the system 200 can create a group based on that identification.

The first computing device 106 identifies a plurality of survey respondents, each of the plurality having generated at least one data point of the identified type in the plurality of survey responses (306). The first computing device generates a group including the identified plurality of survey respondents (308).

Referring now to FIG. 3B, a flow diagram depicts one embodiment of a method 310 for anonymous communication to a survey respondent. In brief overview, the method 310 includes providing, by a first computing device, to a second computing device, access to a visualization representing data in a plurality of survey responses (312). In one embodiment, the first computing device 106 provides the access to the visualization as described above in connection with FIG. 3A (302). The method 310 includes receiving, by the first computing device, from the second computing device, an identification of a type of at least one data point represented in the visualization (314). In one embodiment, the first computing device 106 receives the identification as described above in connection with FIG. 3A (304). The method 310 includes identifying, by the first computing device, a plurality of survey respondents, each of the plurality having generated at least one data point of the identified type in the plurality of survey responses (316). In one embodiment, the first computing device 106 identifies the plurality of survey respondents as described above in connection with FIG. 3A (306). The method 310 includes generating, by the first computing device, a group including the identified plurality of survey respondents (318). In one embodiment, the first computing device 106 provides the access to the visualization as described above in connection with FIG. 3A (308).

The method 310 includes forwarding, by the first computing device, to the group, a message from the second computing device (320). Since the messaging module 220 can determine which ratings each named user has made (and when), the messaging module 220 can create a group to which to send notes requested by the client—without having to pass the identities on to the client. In this way, the system 200 allows the client to isolate a group of users by specifying criteria (e.g., factor, division and group, start and end dates), and then by criteria such as, without limitation:
Selection of the authors of ratings that conform to certain criteria;
Selection of the authors of ratings with recent changes in ratings;
Selection of the authors of ratings based on non-usage of the system since a certain date (i.e., can remind users to providing ratings); and
Selection of the authors of ratings based on identifying users who rate many factors in a similar way.

Referring now to FIG. 2E, a block diagram depicts one embodiment of a user interface 244 for sending an anonymous message to a group.

The computing device 106 includes the messaging module 220. In one embodiment, the messaging module 220 executes on the computing device 106. In another embodiment, the messaging module 220 is provided as a software application. In another embodiment, the messaging module 220 is provided as a hardware application.

In one embodiment, the messaging module 220 allows users and clients to exchange messages. The messages may be notes, as described above. The user is provided with a mechanism for the initial submission of a note, and the ability to request a reply. The user is also provided with a mechanism for viewing replies, which may be archived, and themselves replied to. A client (typically via an authorized user) receives access to a “corporate inbox” mechanism for viewing the initial note submissions by users, which gives them the ability to archive the note, reply to the note, and forward the note to one or more other authorized users.

Referring now to FIG. 2F, a block diagram depicts one embodiment of a user interface 218 with which survey response recipients may view and anonymously respond to survey respondent messages. The client may be provided with a mechanism for viewing said forwarded notes, and a mechanism for viewing notes from users sent in reply; in some embodiments, these two mechanisms may be combined. Similarly, users may be provided with a mechanism for viewing notes received from the messaging module 220 on behalf of the client (e.g., a web page accessed by a computing device 102 of the user or a mobile application executing on a computing device 102 and connecting to the messaging module 220). In some embodiments, the system may restrict how users and clients interact. In one of these embodiments, for example, the system may prevent a client from archiving a note for which a user has requested a reply.

In some embodiments, messaging functionality and the exchange of notes operate in a way that will be familiar to any user of email. However, in other embodiments, the messaging module 220 enables the anonymous exchange of notes, providing a system in which the client can transmit messages to some or all of the surveyed users while protecting the anonymity of the surveyed users. In some embodiments, for example, the client may be provided with a mechanism whereby an initiating note may be sent to a group of users, or to a subset of users that would qualify according to a set of selection criteria as described above to be members of a single group, the identity of any such users being unknown to the client at the time of capture of the initiating note from the client. The messaging module 220 may receive a response to the message from one of the group of users (e.g., a plurality of survey respondents). The messaging module 220 may forward the response to the message to the client.

In one embodiment, the messaging module 220 allows an authorized user to view a note captured from a user. In another embodiment, the client and authorized users remain unaware of the identity of the user. Another embodiment allows the capture of a note from the client in reply to a note previously captured from a user and viewed by the client, irrespective of whether a reply had been requested by said user. A further embodiment allows the capture of a note from a user in reply to a note previously captured from the client or an authorized user in reply to a comment captured from said user. A still further embodiment allows an authorized user to transfer the ability to reply to a note previously captured from a user to another authorized user. In one instantiation, the identity of a user from whom a note is captured is not made available to the client, but the identity of any authorized user replying to said note is made available to said user. Another embodiment allows the client to associate a textual label (“classification”) with a note captured from a user. Yet another embodiment allows the client to specify that a captured note may be automatically given a classification specified by the client depending on the existence of at least one text string specified by the client within the text of said note.

In one embodiment, the messaging module 220 allows the capture of a note from the client, said note being the first note in an intended “conversation” or exchange of notes, rather than being a reply to a note (which may be referred to as an “initiating note”), such that the initiating note is made visible to the users belonging to a group specified by the client and to any authorized user nominated by the client. In another embodiment, the messaging module 220 allows a user belonging to said group, and able to view an initiating note made visible to members of said group, to have a note captured in reply to said initiating note. In still another embodiment, the system allows the client to associate or require the automatic association of a classification with any note captured as part of a sequence of replies to an initiating note. A further embodiment allows the client to perform textual, syntactic, and semantic analysis on any note, sequence of notes given in reply to an initial note, notes created by users in a group, and notes with the same classification or combination of classifications. In some embodiments, the system generates a criterion for inclusion in the group based upon the semantic analysis.

In some embodiments, in addition to allowing clients to anonymously message users, the system 200 allows clients to analyze survey responses based on defined groups. In one of these embodiments, the system 200 allows clients to create and analyze a group including a subset of the users that provided the type of response. In another embodiment, the client accesses arithmetical and statistical analyses as well as data visualizations of ratings at a date that may be specified by the client, the differences between ratings during a date range that may be specified by the client, the consistency of users in having similar ratings for different factors, and the quantity of ratings during a date range that may be specified by the client, where the specification of said date includes the possible additional specification of a time. In a further embodiment, the client specifies a subset of the ratings on which said analyses should be carried out and for which said visualizations should be produced, said subset being definable by at least one restriction, said restrictions being applied either individually or in combination, and including, without limitation:
Ratings captured before a date specified by the client (as one non-limiting example, the client may specify that the analysis include at least one data point captured prior to a date of formation of the group);
Ratings captured on a date specified by the client;
Ratings captured after a date specified by the client;
Ratings captured during a date range specified by the client;
Ratings captured before the end date of a date range specified by the client from those users who had at least one rating captured during said date range;
Ratings captured before the end date of a date range specified by the client from those users who had at least one note captured during said date range;
Ratings captured on at least one factor specified by the client;
Ratings captured from users previously assigned by the client to a leaf division specified by the client;
Ratings captured from users previously assigned by the client to all leaf divisions in the sub-hierarchy according to the appertaining division tree hierarchy of a division specified by the client; and
Ratings captured from users assigned to a group as the result of the client creating the group from qualifying users.
   In some embodiments, the system may receive an identification of a criterion for inclusion in the plurality of survey respondents, the criterion specifying that each of the plurality of survey respondents provide a substantially similar rating for a plurality of factors. In one of these embodiments, the nature of the similarity is part of the criterion. In other embodiments, criteria or restrictions specified as part of identifying a group for analysis may be used in generating a messaging group or groups formed for other purposes, as described herein.

Referring now to FIG. 2G, a block diagram depicts one embodiment of a user interface 240 with which users may request analyses of captured ratings. As shown in FIG. 2G, analyses may include, without limitation, analyses of number of certain types of ratings (e.g., ratings of satisfied users and ratings of unsatisfied users). In other embodiments, the system 200 allows the client to perform any type of analyses on captured data. In further embodiments, the system 200 allows the client to perform analyses but requires that only ratings and notes captured from users in a group specified by the client may be used in the analysis. A further embodiment allows the client to perform analyses such as identifying types of users (e.g., satisfied or unsatisfied) and tracking group membership (e.g., determining how many members of a group have become ex-users over a period of time defined by client).

Referring now to FIG. 2H, a block diagram depicts one embodiment of a user interface 242 with which a user may specify parameters of a ratings analysis. As shown in FIG. 2H, the user may select a factor for analysis (e.g., “salary”), a group of users (e.g., an “Eastern” division), and a date range. The resulting data visualization may be referred to as a “Thymap.” In one embodiment in which the system 200 allows a client to perform analyses on data captured from users, the client is allowed to specify the parameters for an analysis and then execute the analysis. In one embodiment, the results visualization module 210 receives the execution command In another embodiment, the results visualization module 210 passes the execution command to the database 230, which extracts the appropriate data and returns the extracted data to the results visualization module 210. The results visualization module 210 performs the required computational operations on the extracted data and transmits the results to a computing device associated with the client (e.g., to a web browser or application executing on the client's computing device). In some embodiments, the results visualization module 210 transmits the results to the database 230 for storage. The particular analyses implemented in any installation may vary considerably between implementations of the methods and systems described herein as established for various types of client and user.

Referring now to FIG. 3C, a flow diagram depicts one embodiment of a method 330 for anonymous tracking of updates to responses by at least one survey respondent. In brief overview, the method 330 includes providing, by a first computing device, to a second computing device, access to a visualization representing data from a plurality of survey responses (332). In one embodiment, the first computing device 106 provides the access to the visualization as described above in connection with FIG. 3A (302). The method 330 includes receiving, by the first computing device, from the second computing device, an identification of a type of at least one data point represented in the visualization (334). In one embodiment, the first computing device 106 receives the identification as described above in connection with FIG. 3A (304). The method 330 includes identifying, by the first computing device, a plurality of survey respondents, each of the plurality having generated at least one data point of the identified type in the plurality of survey responses (336). In one embodiment, the first computing device 106 identifies the plurality of survey respondents as described above in connection with FIG. 3A (306). The method 330 includes generating, by the first computing device, a group including the identified plurality of survey respondents (338). In one embodiment, the first computing device 106 provides the access to the visualization as described above in connection with FIG. 3A (308). The method 330 includes providing, by the first computing device, to the second computing device, an update by one of the plurality of survey respondents to the type of the at least one data point (340).

In one embodiment, a created group appears to a client like a regular division of users for which the client can track data such as subsequent changes in ratings or memberships. As an example, in some embodiments in which the client is an employer and the users are employees, use of the systems and methods described herein allow an employer to pick a group of employees for whom a factor (e.g., salary) is rated in a certain way (e.g., both important and unsatisfactory), and create a group from those users, without knowing who they are. Continuing with this example, the employer can then send the group a message (e.g., to start a set of anonymous conversations) asking them why they think, for example, that the company salary is too low. In this example, the employer can also track the group to see how many stay with the company, and whether the intervention improves their views over time. In some embodiments, the creation of a group of people based on their views, changes in their views or their usage levels, provides unconventional functionality for clients and users. In one embodiment, a group once created can be tracked, its collective opinions and changes in opinions viewed, and its constituency monitored so the employer knows, for example, how many group members are still with the company. In contrast to conventional systems for collecting and sorting anonymous survey data, the ability to create groups of users based on how they responded to a survey allows clients to track how those particular users' opinions of various factors changed over time. In some embodiments a client can see the opinions of a group prior to a time of formation of the group, which allows a client to determine how opinions of group members have changed over time.

It should be understood that the systems described above may provide multiple ones of any or each of the described components and that these components may be provided on either a standalone machine or, in some embodiments, on multiple machines in a distributed system. It should also be understood that phrases such as “based on” and “based upon” do not imply “based exclusively on” and instead generally mean that the particular feature, structure, step, or characteristic is based at least in part on the specified element. Further, the phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

The systems and methods described above may be implemented using hardware, databases, and programming languages familiar to those of ordinary skill in the art. In one embodiment, the systems and methods leverage distributed computing devices (e.g., what is referred to as cloud-based computing; as another example, embodiments implementing MICROSOFT AZURE), using C# programs and an SQL database running in a cloud-based, or distributed, computing environment, accessed by client and users over the internet via the World Wide Web using a web browser (for example, MICROSOFT Internet Explorer or GOOGLE Chrome) miming those parts of the system instantiated in HTML, CSS, Javascript, and JQUERY. Another embodiment may allow access to the system by means of an executable program running on a desktop or tablet, or by a tablet or smartphone app.

Each computer program within the scope of the claims below may be implemented in any programming language, such as assembly language, machine language, a high-level procedural programming language, or an object-oriented programming language. The programming language may, for example, be LISP, PROLOG, PERL, Python, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, and hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for anonymous communication to survey respondents, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for anonymous communication to survey respondents, the method comprising:
providing, by a first computing device, to a second computing device, access to a visualization representing data from a plurality of survey responses;
receiving, by the first computing device, from the second computing device, an identification of a type of at least one data point represented in the visualization;
identifying, by the first computing device, a plurality of survey respondents, each of the plurality having generated at least one data point of the identified type in the plurality of survey responses;
generating, by the first computing device, a messaging group including the identified plurality of survey respondents; and
forwarding, by the first computing device, to the messaging group, a message from the second computing device.

2. The method of claim 1 further comprising capturing, by a survey administration module executing on the first computing device, survey response data from the plurality of survey respondents.

3. The method of claim 1, wherein providing further comprises obfuscating the visualized data by modifying a position of at least one data point.

4. The method of claim 1, wherein receiving further comprises receiving the identification without a user of the second computing device knowing the identity of the users generating the type of data point.

5. The method of claim 1 further comprising receiving an identification of a criterion for inclusion in the plurality of survey respondents, the criterion specifying the type of the at least one data point represented in the visualization.

6. The method of claim 1 further comprising receiving an identification of a criterion for inclusion in the plurality of survey respondents, the criterion specifying that a numerical rating provided by a survey respondent shall have changed by a specific amount during a period of time.

7. The method of claim 1 further comprising receiving an identification of a criterion for inclusion in the plurality of survey respondents, the criterion specifying that each of the plurality of survey respondents provide a substantially similar rating for a plurality of factors.

8. The method of claim 1 further comprising receiving an identification of a criterion for inclusion in the plurality of survey respondents, the criterion specifying that a text-based response provided by a survey respondent shall include a keyword.

9. The method of claim 1, wherein receiving further comprises receiving an indication to create a group including the plurality of survey respondents.

10. The method of claim 1, wherein generating further comprises generating the messaging group without passing survey respondent identities to the second computing device.

11. The method of claim 1 further comprising receiving, by a messaging module executing on the first computing device, from the second computing device, the message for the messaging group.

12. The method of claim 1 further comprising receiving, from one of the plurality of survey respondents receiving the message, a response to the message.

13. The method of claim 12 further comprising forwarding, by the first computing device, to the second computing device, the response to the message.

14. The method of claim 12 further comprising performing, by the first computing device, a semantic analysis on the response to the message.

15. The method of claim 14, further comprising generating a criterion for inclusion in the plurality of survey respondents based upon the semantic analysis.

16. A method for analysis of groups of survey respondents, the method comprising:
providing, by a first computing device, to a second computing device, access to a visualization representing data from a plurality of survey responses;
receiving, by the first computing device, from the second computing device, an identification of a type of at least one data point represented in the visualization;
identifying, by the first computing device, a plurality of survey respondents, each of the plurality having generated at least one data point of the identified type in the plurality of survey responses;
generating, by the first computing device, a group including the identified plurality of survey respondents; and
providing, by the first computing device, to the second computing device, access to a result of a statistical analysis of the plurality of survey responses provided by the plurality of survey respondents in the group.

17. The method of claim 16 further comprising providing, by the first computing device, to the second computing device, a visualization of the result of the statistical analysis.

18. The method of claim 16, wherein receiving further comprises receiving a specification of a subset of the at least one data point for analysis, the subset defined by at least one restriction.

19. The method of claim 16, wherein providing access to the result further comprises providing a result of tracking group membership over a period of time.

20. The method of claim 16, wherein providing access to the result further comprises providing a result of an analysis of at least one data point captured prior to a date of formation of the group.

21. A non-transitory, computer readable medium comprising computer program instructions stored thereon, wherein the computer program instructions are executable by at least one computer processor to perform a method for anonymous communication to survey respondents, the method comprising:
providing, by a first computing device, to a second computing device, access to a visualization representing data from a plurality of survey responses;
receiving, by the first computing device, from the second computing device, an identification of a type of at least one data point represented in the visualization;
identifying, by the first computing device, a plurality of survey respondents, each of the plurality having generated at least one data point of the identified type in the plurality of survey responses;
generating, by the first computing device, a messaging group including the identified plurality of survey respondents; and
forwarding, by the first computing device, to the messaging group, a message from the second computing device.
